(19) United States
(12) Patent Application Publication
(10) Pub. No.: US 2026/0264149 A1
(43) Pub. Date: Sep. 10, 2026

(54) ADDITIVE MANUFACTURING WITH DYNAMIC MAGNETIC FIELDS

(71) Applicant: Divergent Technologies, Inc., Los Angeles, CA (US)

(72) Inventors: Gordon TAJIRI, Los Angeles, CA (US); Taiki Thomas SHIRAI, Irvine, CA (US); Son Vi QUANG, San Gabriel, CA (US)

(73) Assignee: Divergent Technologies, Inc., Los Angeles, CA (US)

(21) Appl. No.: 19/555,163

(22) Filed: Mar. 3, 2026

Related U.S. Application Data
(60) Provisional application No. 63/766,311, filed on Mar. 3, 2025.

(51) Int. Cl. B22F 10/50; B22F 10/22; B22F 12/30; B22F 12/90; B33Y 10/00; B33Y 30/00; B33Y 40/00

(52) U.S. Cl. CPC B22F 10/50; B22F 10/22; B22F 12/30; B22F 12/90; B33Y 10/00; B33Y 30/00; B33Y 40/00; B22F 2202/05; B22F 2998/10

(57) ABSTRACT

A method of and a three dimensional (3D) printing system for melting material into a melt pool and enabling a dynamic magnetic field to create a thermal electromagnetic force in the melt pool. The method and 3D printing system may depositor the material on a build plate and apply an energy beam to melt the material. The material may be deposited into a plurality of layers, where the melt pool may be within one or more of the plurality of layers and the energy beam may additionally form a liquid in the one or more of the plurality of layers such that the thermal electromagnetic force causes a fluid flow within the liquid and the melt pool. The method and 3D printing system may control the dynamic magnetic field across the build plate. The dynamic magnetic field may be generated by segmented and independent electromagnetic coils.

### CROSS-REFERENCE TO RELATED APPLICATIONS

This application claims the benefit of U.S. Provisional Application Ser. No. 63/766,311, entitled “Microstructure and Crack Mitigation via Dynamic Magnetic Fields” and filed on Mar. 3, 2025, which is expressly incorporated by reference herein in its entirety.

### BACKGROUND

### Field

The disclosure relates generally to using a dynamic magnetic field with additive manufacturing.

### Background

Three-dimensional (3D) printing, also referred to as additive manufacturing (AM), has recently presented new opportunities to more efficiently build complex structures, where these structure may form or form portions of transport structures such as automobiles, aircraft, drones, boats, motorcycles, buses, trains, and the like. AM techniques are capable of fabricating structures from various materials. Applying AM processes to industries that produce these structures has proven to produce more efficient structures. For example, structures 3D printed may be made strong, ductile, light, and consequently, produce fuel efficient transport structures. Moreover, AM enables manufacturers to 3D print structures that are more complex in shape and form and that are equipped with more advanced features and capabilities than structures made using traditional machining and casting techniques. However, 3D printing materials (e.g., alloys) may possess problems. For example, 3D printing materials may create defects such as pores and cracks in the 3D printed structure. The coalescence of dense populations of pore defects and cracks will reduce the strength and fatigue life of the 3D printed structure.

### SUMMARY

In this disclosure, it is recognized that influencing the melt pool and a heat affected zone with a dynamic magnetic field can eliminate or reduce pore defects and cracks, and thus, improve material performance and reliability of a 3D printed structure. In various embodiments, many advantages may be realized as described in more detail below for various embodiments. For example, benefits may include improving bulk material properties, (e.g., yield strength (σ_{y}), ultimate tensile strength (σᵤₗₜ), ductility, elongation, etc.) reducing defects, (e.g., pores, cracks, etc.) and increasing overall printed structure quality.

In one or more embodiments disclosed herein is a method including depositing a plurality of layers of material onto a build plate, applying an energy beam to the material to melt the material into a melt pool and generating a dynamic magnetic field such that the dynamic magnetic field creates a thermal electromagnetic force in the melt pool.

In one or more embodiments, the method may further include forming one or more fractures (e.g., micro-fractures) on one or more dendritic arms based on the thermal electromagnetic force.

In one or more embodiments, the method may further include forming a fluid flow within the melt pool, wherein the fluid flow is based on the thermal electromagnetic force.

In one or more embodiments, the method may further include forming a fluid backflow between dendrites, wherein the fluid backflow is based on the fluid flow.

In one or more embodiments, the energy beam may further melt the material in a first layer of the plurality of layers into a liquid.

In one or more embodiments, the thermal electromagnetic force may form a fluid flow within the liquid.

In one or more embodiments, the method may further include controlling the dynamic magnetic field across the build plate.

In one or more embodiments, controlling the dynamic magnetic field may include directing the dynamic magnetic field normal to the build plate and the material.

In one or more embodiments, controlling the dynamic magnetic field may include directing the dynamic magnetic field parallel to the build plate and the material.

In one or more embodiments, controlling the dynamic magnetic field may include tuning the build plate to increase a magnetic flux through the build plate.

In one or more embodiments, tuning the build plate may include forming the build plate with a nickel material.

In one or more embodiments, controlling the dynamic magnetic field may include changing a magnetic field strength of the dynamic magnetic field.

In one or more embodiments, changing the magnetic field strength may include pulsing the dynamic magnetic field.

In one or more embodiments, pulsing the dynamic magnetic field may include a pulsed square wave or a pulsed sawtooth wave or a pulsed half-sine wave.

In one or more embodiments, changing the magnetic field strength may include reversing the dynamic magnetic field.

In one or more embodiments, reversing the dynamic magnetic field may include a reversed square wave or a reversed sawtooth wave or a reversed sinusoidal wave.

In one or more embodiments disclosed herein is a 3D printing system including a depositor configured to deposit material onto a build plate, an energy beam deflector that applies an energy beam to melt the material into a melt pool and an electromagnet configured to generate a dynamic magnetic field across the material such that the dynamic magnetic field creates a thermal electromagnetic force in the melt pool.

In one or more embodiments, the build plate may include a nickel material.

In one or more embodiments, the 3D printing system may further include a controller.

In one or more embodiments, the controller may be configured to pulse the dynamic magnetic field.

In one or more embodiments, the pulsed dynamic magnetic field may include a pulsed square wave or a pulsed sawtooth wave or a pulsed half-sine wave.

In one or more embodiments, the controller may be configured to reverse the dynamic magnetic field.

In one or more embodiments, the reversed dynamic magnetic field may include a reversed square wave or a reversed sawtooth wave or a reversed sinusoidal wave.

In one or more embodiments, the 3D printing system may further include a build cylinder, wherein the electromagnet is coupled to the build cylinder.

In one or more embodiments, the electromagnet may include electromagnetic coils around the build cylinder.

In one or more embodiments, the 3D printing system may further include an inlet duct and an exhaust duct. The electromagnet may include a first set of electromagnetic coils and a second set of electromagnetic coils. The first set of electromagnetic coils may be coupled to the inlet duct and the second set of electromagnetic coils may be coupled to the exhaust duct.

In one or more embodiments, the inlet duct may be configured to provide a gas flow across the material, and the exhaust duct may be configured to receive the gas flow.

In one or more embodiments, the electromagnet may include a plurality of segmented electromagnetic coils.

In one or more embodiments, a first coil of the plurality of segmented electromagnetic coils may be configured to generate a first dynamic magnetic field, and a second coil of the plurality of segmented electromagnetic coils may be configured to generate a second dynamic magnetic field. A magnetic field strength of the first dynamic magnetic field may be the same or different from a magnetic field strength of the second dynamic magnetic field.

It will be understood that other aspects of a 3D printing system to form and methods of forming structures by influencing the melt pool with a dynamic magnetic field will become readily apparent to those skilled in the art from the following detailed description, wherein it is shown and described several embodiments only by way of illustration. As will be realized by those skilled in the art, these methods and systems are capable of other and different embodiments, and its several details are capable of modification in various other respects, all without departing from the disclosure. Accordingly, the drawings and detailed description are to be regarded as illustrative in nature and not as restrictive.

### BRIEF DESCRIPTION OF THE DRAWINGS

Various aspects of a 3D printing system to form and methods of forming structures by influencing the melt pool and a heat affected zone with a dynamic magnetic field will now be presented in the detailed description by way of example, and not by way of limitation, in the accompanying drawings, wherein:

FIGS. 1A-1D illustrate respective side views of a 3D printer system in accordance with an aspect of the present disclosure.

FIG. 1E illustrates a functional block diagram of a 3D printer system in accordance with an aspect of the present disclosure.

FIG. 2 illustrates a cross-sectional view of electromagnetic coils coupled to a build cylinder in accordance with an aspect of the present disclosure.

FIG. 3 illustrates a perspective view of an example melt pool in accordance with an aspect of the present disclosure.

FIG. 4 illustrates a cross-sectional view of electromagnetic coils coupled to inlet and exhaust ducts in accordance with an aspect of the present disclosure.

FIG. 5 illustrates a perspective view of an example melt pool in accordance with an aspect of the present disclosure.

FIG. 6 illustrates an example of a pulsed dynamic magnetic field being a pulsed square wave.

FIG. 7 illustrates an example of a pulsed dynamic magnetic field being a pulsed sawtooth wave.

FIG. 8 illustrates an example of a pulsed dynamic magnetic field being a pulsed half-sine wave.

FIG. 9 illustrates an example of a reversed dynamic magnetic field being a reversed square wave.

FIG. 10 illustrates an example of a reversed dynamic magnetic field being a reversed sawtooth wave.

FIG. 11 illustrates an example of a reversed dynamic magnetic field being a reversed sinusoidal wave.

FIG. 12 illustrates a cross-sectional view of an example melt pool and heat affected zone in accordance with an aspect of the present disclosure.

FIG. 13 illustrates a cross-sectional view of an example solidification process of the melt pool and the heat affected zone in accordance with an aspect of the present disclosure.

FIG. 14 illustrates a cross-sectional view of an example melt pool including fractured particles of dendrites in accordance with an aspect of the present disclosure.

FIG. 15 illustrates a flowchart showing an example method in accordance with the apparatuses, systems and methods described herein.

### DETAILED DESCRIPTION

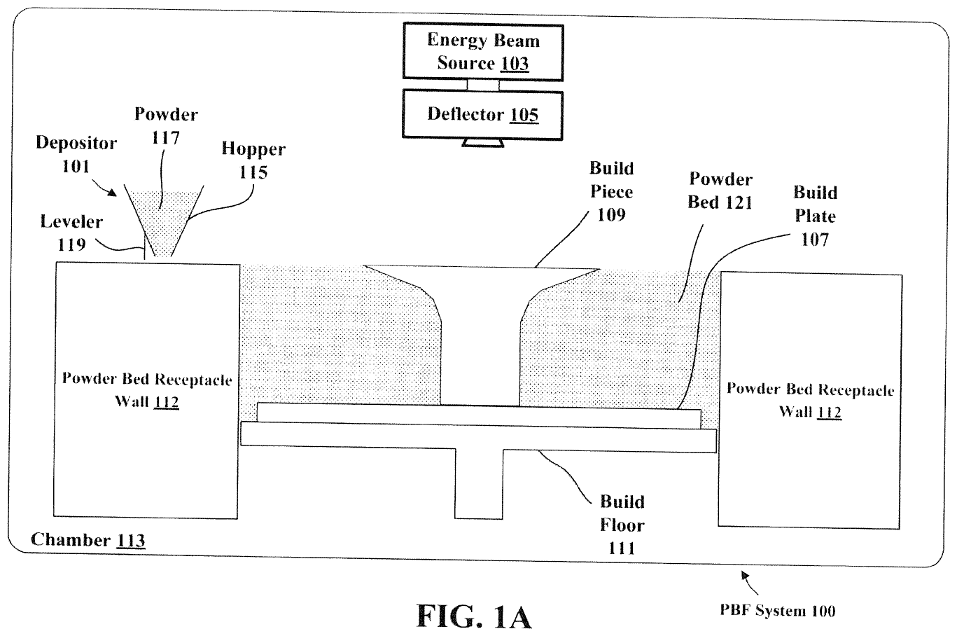

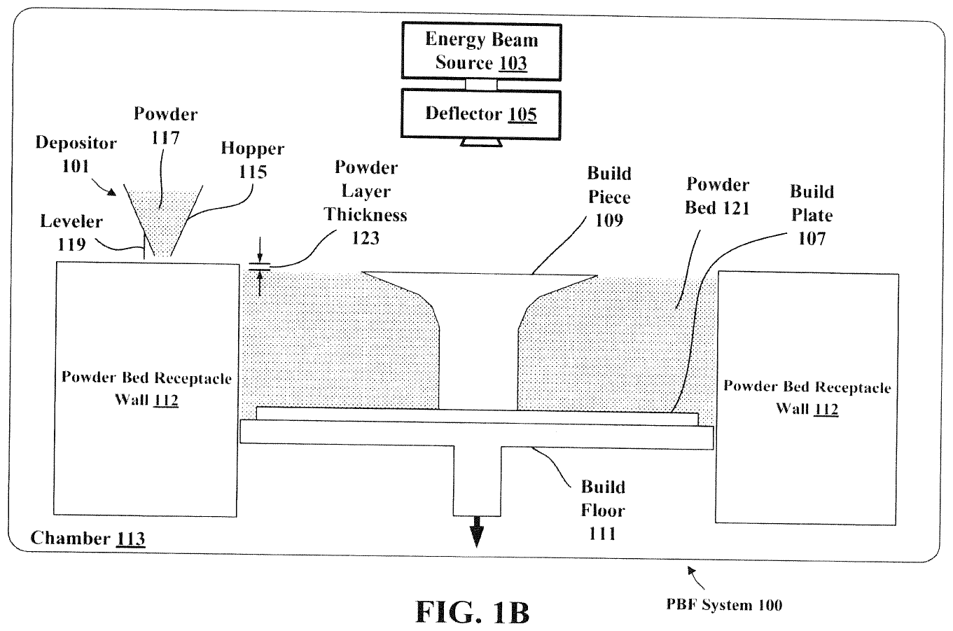

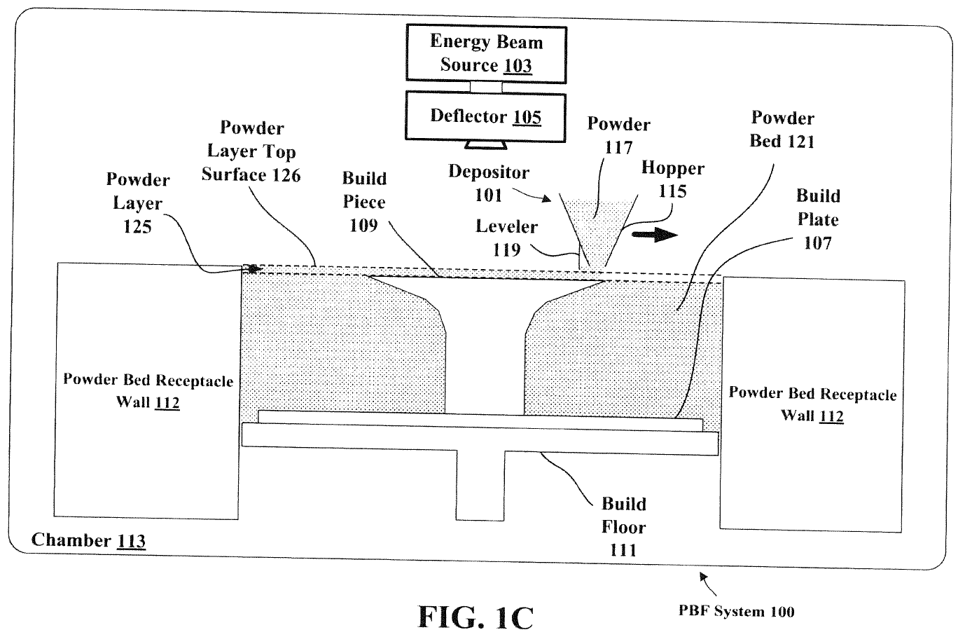

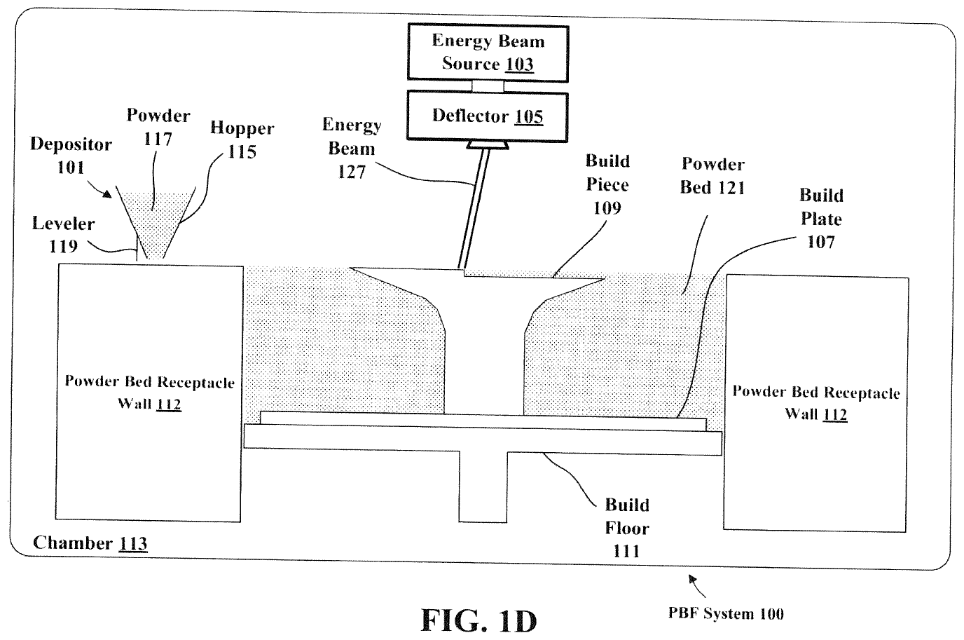

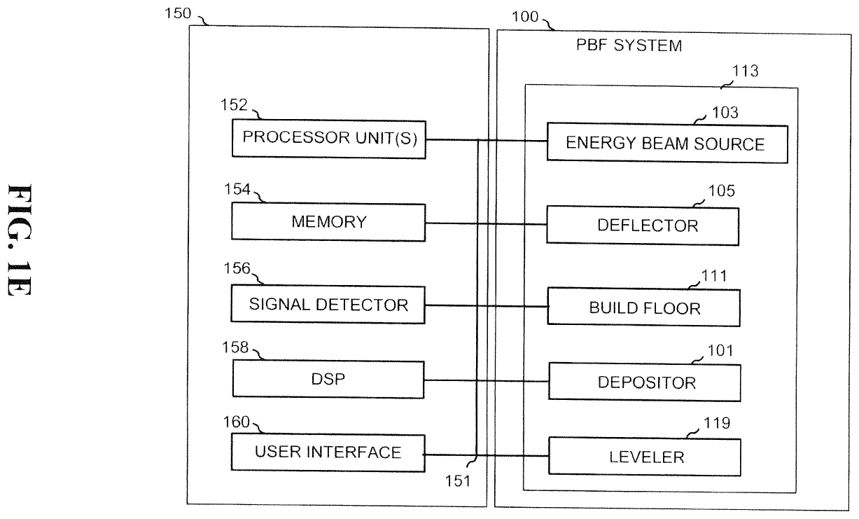

To overcome the above mentioned problems associated with 3D printing, the need is felt to come up with 3D printing materials such that the microstructure within a melt pool and a heat affected zone is affected by a dynamic magnetic field during the 3D printing process to improve bulk material properties, reduce defects, and increase overall print quality of the 3D printed structure. For example, affecting the microstructure of a structure may include influencing the melt pool and the heat affected zone with the dynamic magnetic field such that pore defects and cracks may be prevented and/or reduced during the 3D printing process and the material strength and elongation of the 3D printed structure may be increased. The 3D printing process may include a melting process (e.g., phase transformation of a solid into a liquid) such as melting of the material in one or more layers of deposited material and a solidification process (e.g., phase transformation of the liquid into a solid) of melted material. The 3D printing process may be laser bed printing, for example, using a powder bed fusion (PBF) system or other AM systems. For example, the powder bed fusion system may be the PBF system 100 discussed and illustrated in FIGS. 1A-1E.

The detailed description set forth below in connection with the drawings is intended to provide a description of example embodiments of apparatuses, systems and methods. For example, the apparatuses, systems and methods influence the melt pool and a heat affected zone with a dynamic magnetic field to eliminate or reduce pore defects and cracks, increase material strength and elongation of a 3D printed structure, and thus, improve material performance and reliability of the 3D printed structure. The apparatuses, systems and methods are not intended to represent the only embodiments in which the disclosure may be practiced. The terms “exemplary” or “example” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the disclosure to those skilled in the art. However, the disclosure may be practiced without these specific details. In some instances, well-known structures and components may be shown in block diagram form, or omitted entirely, in order to avoid obscuring the various concepts presented throughout this disclosure.

### Additive Manufacturing

Additive Manufacturing (AM) involves the use of a stored geometrical model for accumulating layered materials on a build plate to produce a three-dimensional (3D) build piece having features defined by the model. AM techniques are capable of printing simple and complex structures using a wide variety of materials. A 3D structure may be fabricated based on a computer aided design (CAD) model. The CAD model can be used to generate a set of instructions or commands that are compatible with a particular 3D printer. The AM process can create/manufacture a three-dimensional structure using the CAD model and print instructions. In the AM process, different materials or combinations of material, such as engineered plastics, thermoplastic elastomers, metals, powder (e.g., metal powder), ceramics, and/or alloys or combinations of the above, etc., may be used to create a three-dimensional structure.

The use of producing AM structures may provide significant flexibility and cost saving benefits. These, and other benefits may enable manufacturers of mechanical structures to produce the structures at a lower cost and in a more efficient manner. The techniques described in the present disclosure relate to apparatuses, systems and methods of manufacturing structures. The AM (e.g., 3D printed) structures that are printed by, for example, adding layer upon layer of one or more materials based on a preprogramed design. For example, the structure may be formed by a powder bed fusion (PBF) system/printer. The structures described herein may be structures used to assemble a variety of devices and apparatuses, such as a automobiles, aircraft, drones, boats, motorcycles, buses, trains, and the like, or other mechanized assemblies, without departing from the scope of the present disclosure. Assembly of these structures may be performed robotically (e.g., by robots) or manually or a combination of manual and robotic assembly.

### Structures and Terminology in AM

In an aspect of the present disclosure, a structure may be an example of an AM structure or a structure manufactured by other manufacturing methods. The structure may include structures joined together that form part of or form automobiles, aircraft, drones, boats, motorcycles, buses, trains, and their components, and the like. A structure may be any 3D printed structure that includes features, such as an interface, for mating with another component. The structure may have internal or external features configured to accept a particular type of structure. Alternatively or additionally, the structure may be shaped to accept a particular type of structure. A structure may utilize any internal design or shape and accept any variety of structures without departing from the scope of the disclosure.

A structure interface may be configured to connect to an interface of another structure. For example, and not by way of limitation, an interface between structures may include a tongue-and-groove structure. The interface may include high precision features or complex geometries that allow them to perform specific functions, including creating connections to spanning structures such as tubes, structural panels, extrusions, sheet metal, and/or other structural members.

For clarity, structures may also include relatively simple connection features configured to connect with a more sophisticated network of connection features of the interface to form streamlined connections between structures. While these structures may incorporate more basic features, they advantageously may be 3D printed at a higher print rate. Alternatively, structures may be built/manufactured using any 3D print manufacturing.

A number of different AM technologies may be well-suited for construction of structures in a transport structure or other mechanized assembly. Such 3D printing techniques may include, for example, directed energy deposition (DED), selective laser melting (SLM), selective laser sintering (SLS), direct metal laser sintering (DMLS), electron beam melting (EBM), powder bed fusion (PBF), and/or other AM processes involving melting or fusion of metallic powders.

As in many 3D printing techniques, these systems and processes (e.g., PBF systems and processes) can create build pieces (e.g., structures) layer-by-layer. Each layer or “slice” is formed by depositing a layer of powder and exposing portions of the powder to an energy beam. The energy beam is applied to melt areas of the powder layer that coincide with the cross-section of the build piece in the layer. The melted powder cools and fuses to form a slice of the build piece. The process can be repeated to form the next slice of the build piece, and so on. Each layer is deposited on top of the previous layer. The resulting structure is a build piece assembled slice-by-slice from the ground up. SLS and various other PBF techniques may be well suited to construction of structures for transport or other structures. However, it will be appreciated that other AM techniques, such as fused deposition modeling (FDM) and the like, are also possible for use in such applications.

AM may include the manufacture of one or more structures. Using AM, a structure may be constructed to include additional features and functions, including interface functions, depending on the objectives.

### Additive Manufacturing Environment

FIGS. 1A-1D illustrate respective side views of a 3D printer system (e.g., a PBF system) in an aspect of the present disclosure.

In an aspect of the present disclosure, a 3D printer system may be a powder-bed fusion (PBF) system 100. FIGS. 1A-D show PBF system 100 during different stages of operation. The particular embodiment illustrated in FIGS. 1A-1D is one of many suitable examples of a PBF system employing principles (e.g. creating and manufacturing one or more structures) of this disclosure. It should also be noted that elements of FIGS. 1A-1D and the other figures in this disclosure are not necessarily drawn to scale, but may be drawn larger or smaller for the purpose of better illustration of concepts described herein. PBF system 100 may include a depositor 101 that can deposit each layer 125 of powder 117 (e.g., metal powder), an energy beam source 103 that can generate an energy beam 127, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 may also include a build floor 111 positioned within a powder bed receptacle. The walls 112 of the powder bed receptacle generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 may include a hopper 115 that contains a powder 117, such as a metal powder, and a leveler 119 that can level the top of each layer of deposited powder.

Referring specifically to FIG. 1A, FIG. 1A illustrates PBF system 100 after a slice of build piece 109 has been fused, but before the next layer of powder has been deposited. In fact, FIG. 1A illustrates a time at which PBF system 100 has already deposited and fused slices in multiple layers, e.g., 200 individual layers, to form the current state of build piece 109, e.g., formed of 200 individual slices. The multiple individual layers already deposited have created a powder bed 121, which includes powder that was deposited but not fused.

FIG. 1B illustrates PBF system 100 at a stage in which build floor 111 can lower by a powder layer thickness 123. The lowering of build floor 111 causes build piece 109 and powder bed 121 to drop by powder layer thickness 123, so that the top of build piece 109 and powder bed 121 are lower than the top of powder bed receptacle wall 112 by an amount equal to the powder layer thickness 123. In this way, for example, a space with a consistent thickness equal to powder layer thickness 123 can be created over the tops of build piece 109 and powder bed 121.

FIG. 1C illustrates PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that leaves powder layer top surface 126 configured to receive fusing energy from energy beam source 103. Powder layer 125 has a thickness substantially equal to the powder layer thickness 123 (see FIG. 1B). Thus, the powder in a PBF system can be supported by a powder material support structure, which may include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving the 200 previously-deposited individual layers discussed above with reference to FIG. 1A.

FIG. 1D illustrates PBF system 100 at a stage in which, following the deposition of powder layer 125 (FIG. 1C), energy beam source 103 generates an energy beam 127 and deflector 105 applies the energy beam to fuse the next slice in build piece 109. In various embodiments, energy beam source 103 may be an electron beam source, in which case energy beam 127 constitutes an electron beam. Deflector 105 may include deflection plates that can generate an electric field or a magnetic field that selectively deflects the electron beam to cause the electron beam to scan across areas designated to be fused. In various embodiments, energy beam source 103 may be a laser, in which case energy beam 127 is a laser beam. Deflector 105 may include an optical system that uses reflection and/or refraction to manipulate the laser beam to scan selected areas to be fused.

In various embodiments, the deflector 105 may include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam may be modulated by a digital signal processor (DSP).

FIG. 1E illustrates a functional block diagram of a 3D printer system in accordance with an aspect of the present disclosure.

In an aspect of the present disclosure, control devices and/or elements, including computer software, may be coupled to PBF system 100 to control one or more components within PBF system 100. Such a control device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may include one or more processor units 152, memory 154, a signal detector 156, a digital signal processor (DSP) 158, and one or more user interfaces 160. Computer 150 may include additional components without departing from the scope of the present disclosure.

The computer 150 may include one or more processor units 152, which may assist in the control and/or operation of PBF system 100. The processor unit 152 may also be referred to as a central processing unit (CPU). Memory 154, which may include both read-only memory (ROM) and random access memory (RAM), may provide instructions and/or data to the processor. A portion of the memory 154 may also include non-volatile random access memory (NVRAM). The processor 152 typically performs logical and arithmetic operations based on program instructions stored within the memory 154. The instructions in the memory 154 may be executable (by the processor unit 152, for example) to implement the methods described herein.

The processor unit 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor unit 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

The computer 150 may also include a signal detector 156 that may be used to detect and quantify any level of signals received by the computer 150 for use by the processing unit 152 and/or other components of the computer 150. The signal detector 156 may detect such signals as energy beam source 103 power, deflector 105 position, build floor 111 height, amount of powder 117 remaining in depositor 101, leveler 119 position, and other signals. Signal detector 156, in addition to or instead of processor unit 152 may also control other components as described with respect to the present disclosure. The computer 150 may also include a DSP 158 for use in processing signals received by the computer 150. The DSP 158 may be configured to generate instructions and/or packets of instructions for transmission to PBF system 100.

The computer 150 may further comprise a user interface 160 in some aspects. The user interface 160 may include a keypad, a pointing device, and/or a display. The user interface 160 may include any element or component that conveys information to a user of the computer 150 and/or receives input from the user.

The various components of the computer 150 may be coupled together by a bus system 151. The bus system 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor unit 152 may be used to implement not only the functionality described above with respect to the processor unit 152, but also to implement the functionality described above with respect to the signal detector 156, the DSP 158, and/or the user interface 160. Further, each of the components illustrated in FIG. 1E may be implemented using a plurality of separate elements.

By way of example, an element, or any portion of an element, or any combination of elements may be implemented using one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors may execute software as described above.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium includes a non-transitory computer readable medium (e.g., tangible media).

### Apparatus, System and Process

The disclosure provides example apparatuses, systems and processes for forming one or more structures (i.e., build piece(s)) using 3D printing. The 3D printing process may be laser bed printing, for example, using a powder bed fusion (PBF) system or other AM systems. For example, the powder bed fusion system may be the PBF system 100 discussed and illustrated in FIGS. 1A-1E.

A Thermal Electromagnetic Force (TEMF) is created due to a magnetic field and a thermoelectric (Seebeck) current, and may be expressed as F_{TE} in formula (1)

$${F}_{TE} = {J}_{TE} \times B = \frac{{σ}_{L} {σ}_{S} {f}_{S}}{{σ}_{L} {f}_{L} + {σ}_{S} {f}_{S}} ( {η}_{S} - {η}_{L} ) Δ T \times B , \qquad ( 1 )$$

where F_{TE} is the TEMF
density, J_{TE} is the current density, B is the magnetic field intensity, σ_{L} is the electrical conductivity of liquid phase, σ_{S} is the electrical conductivity of solid phase, f_{L} is the volume fraction of liquid phase, f_{S} is the volume fraction of solid phase, η_{L} is the thermoelectric power of liquid phase, η_{S} is the thermoelectric power of solid phase, and ΔT is the temperature gradient. The thermoelectric current is due to a materials temperature difference and may be known as the Seebeck effect, which is the emergence of an electromotive force (EMF) that develops across two points of an electrically conducting material when there is a temperature difference between them and this EMF leads to a thermoelectric current that may be measured. This temperature difference is present in the melt pool and in the liquid in the heat affected zone. For example, the rapid melting of the material in the melt pool and the heat affected zone via the energy beam and the extremely high cooling rate of the melted material in the melt pool and the heat affected zone create a temperature difference in the melt pool and in the liquid in the heat affected zone. The cooling rate may be from approximately 10³° C./second to approximately 10⁶° C./second in the 3D printing system and method disclosed here within. Thus, this disclosure creates the Thermal Electromagnetic Force (TEMF) in the melt pool (e.g., the liquid in the melt pool) and in the liquid in the heat affected zone with a dynamic magnetic field generated by an electromagnet as will be described in detail via the various embodiments.

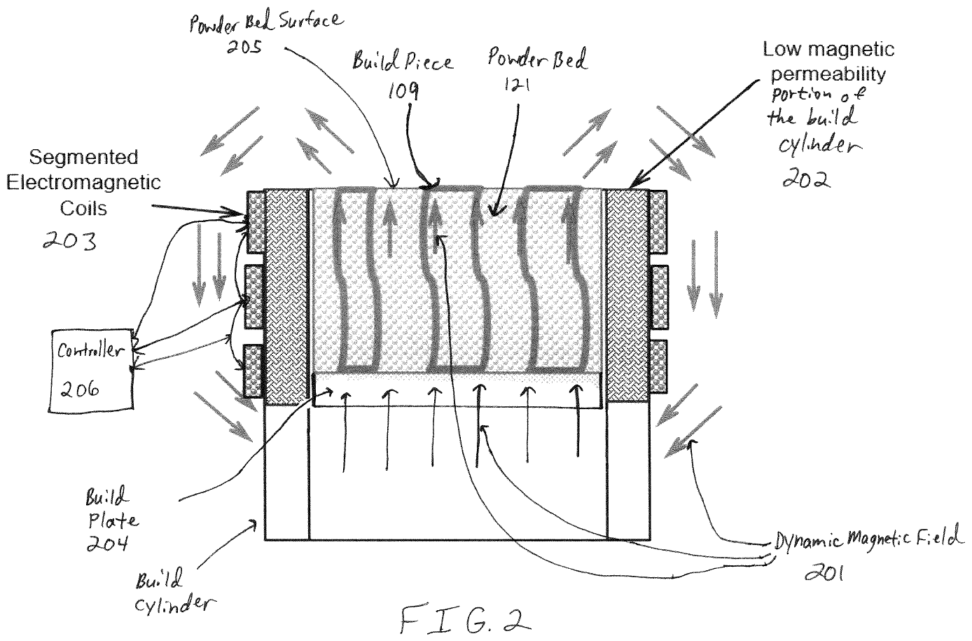

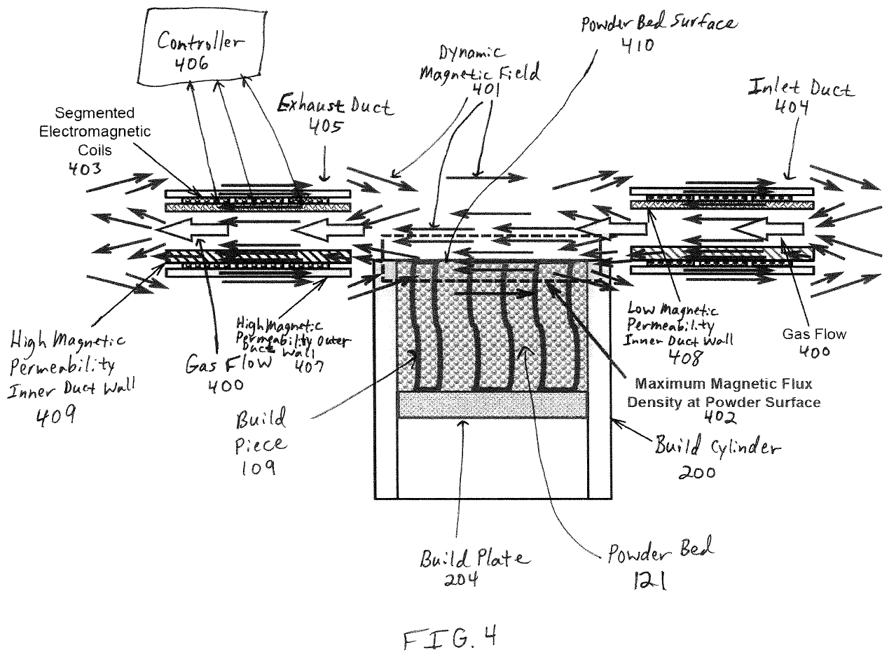

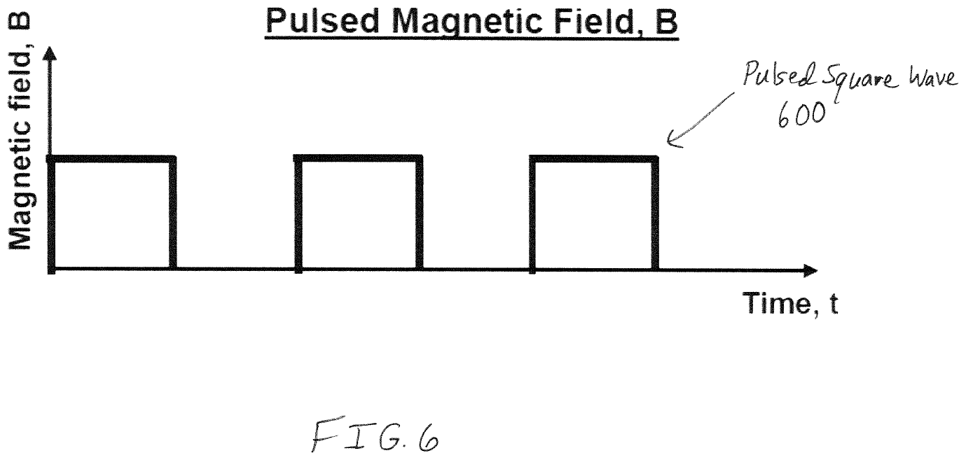

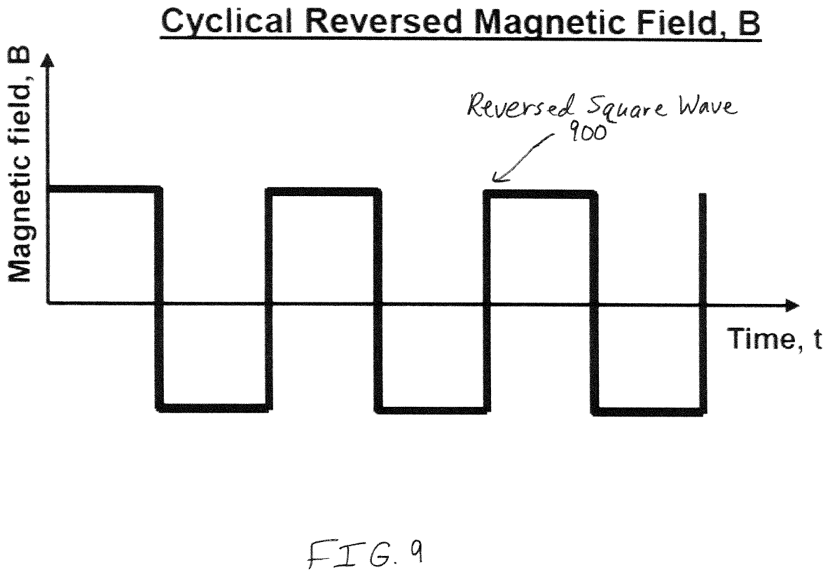

FIG. 2 illustrates an example of segmented electromagnetic coils 203 coupled to a build cylinder 200 and generating a dynamic magnetic field 201 across the material (e.g., powder or powder bed surface), which as shown in FIG. 2 the dynamic magnetic field is normal (i.e., perpendicular) to a build plate 204 and to a powder bed surface 205 of powder bed 121. The number of segmented electromagnetic coils may be more or less than the number shown in FIG. 4. In one or more embodiments, the dynamic magnetic field may be at an angle to the build plate and the powder bed surface different from the angle to the build plate and the powder bed surface illustrated in FIG. 2. FIG. 2 also illustrates three example build pieces 109 formed on the build plate. There may be more or less build pieces formed on the build plate than illustrated in FIG. 2. For example, ten build pieces may be formed on the build plate using a powder bed fusion (PBF) system or other AM systems. The powder bed fusion system may be the PBF system 100 discussed and illustrated in FIGS. 1A-1E. Also, the PBF system 100 of FIGS. 1A-1E may include the build cylinder. FIG. 2 illustrates the segmented electromagnetic coils around the build cylinder. In one or more embodiments, any type or quantity of an electromagnet that generates a dynamic magnetic field may be coupled to the build cylinder or may be around the build cylinder or coupled to sleeve positioned around the build cylinder. For example, the segmented electromagnetic coils may be independent from one another and each coil may be independently controlled by a controller 206. For example, the controller may be coupled to each of the segmented electromagnetic coils and configured to control each of the segmented electromagnetic coils generated dynamic magnetic field. In one or more embodiments, the controller may control the dynamic magnetic field by changing the magnetic field strength of the dynamic magnetic field. For example, changing the magnetic field strength of the dynamic magnetic field may include changing the magnetic field strength of a dynamic magnetic field from one (e.g., a first) of the segmented electromagnetic coils and changing the magnetic field strength of a dynamic magnetic field from another (e.g., a second) of the segmented electromagnetic coils such that the first segmented electromagnetic coil generates the same or a different magnetic field strength than the second segmented electromagnetic coil. Another example of changing the magnetic field strength of the dynamic magnetic field may include pulsing the dynamic magnetic field and/or reversing the dynamic magnetic field. In one or more embodiments, pulsing the dynamic magnetic field may include the dynamic magnetic field having a pulsed square wave or a pulsed sawtooth wave or a pulsed half-sine wave as shown in FIGS. 6-8 or other pulsed wave forms. In one or more embodiments, reversing the dynamic magnetic field may include the dynamic magnetic field having a reversed square wave or a reversed sawtooth wave or a reversed sinusoidal wave as shown in FIGS. 9-11 or other reversed wave forms. Because the build cylinder 200 may include a low magnetic permeability portion 202 for the dynamic magnetic field to penetrate, the build plate 204 may be tuned to include a shape which increases the magnetic flux through the build plate and/or may include a material which increases the magnetic flux through the build plate. For example, the build plate may include one or more angled side portions that are perpendicular to the dynamic magnetic field and may include a horizontal middle portion which is also perpendicular to the dynamic magnetic field. The build plate material may include nickel or a nickel alloy or cobalt or iron or other material that has high permeability to the dynamic magnetic field. The low magnetic permeability portion of the build cylinder may include stainless steel or aluminum or other material having a low magnetic flux of the dynamic magnetic field.

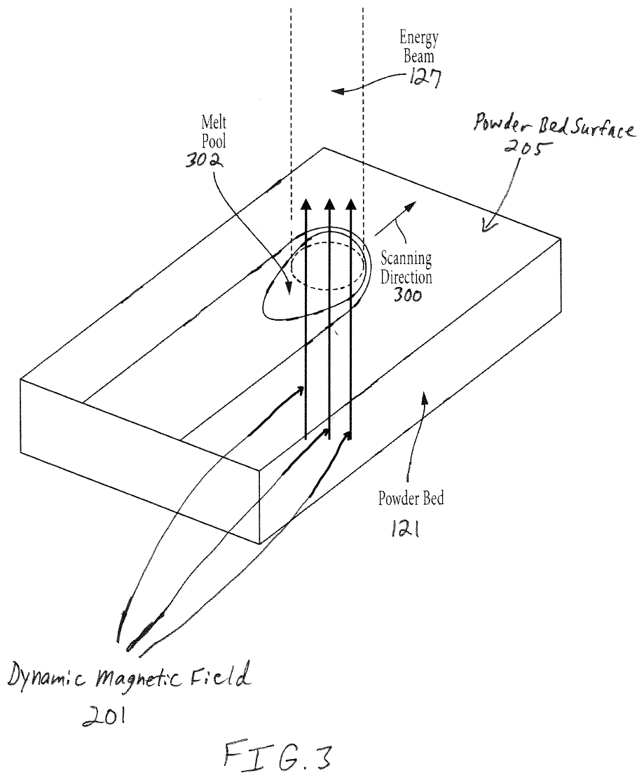

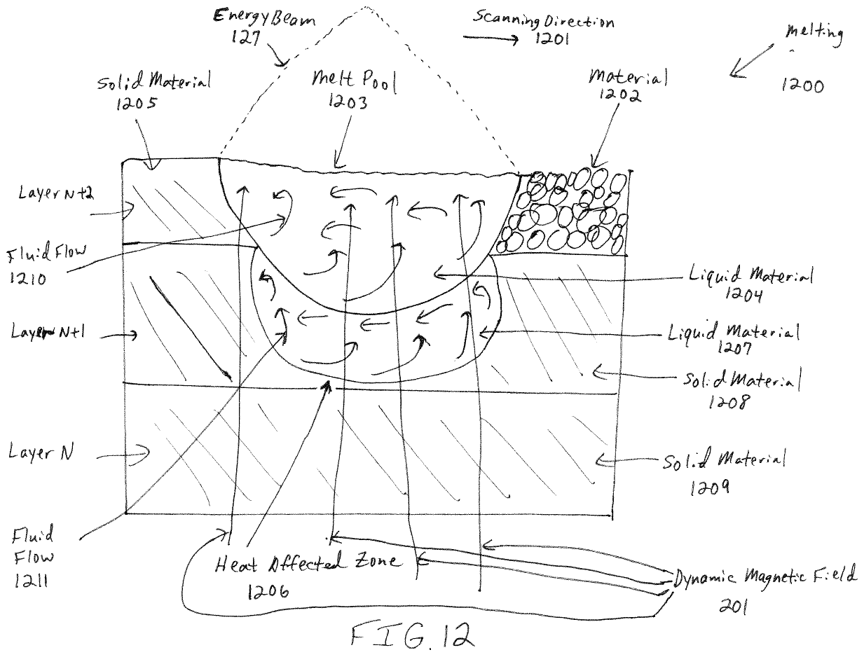

FIG. 3 illustrates a perspective view showing more details of the powder bed surface of FIG. 2. FIG. 3 illustrates a scanning direction 300 of the energy beam 127, where the energy beam melts material (e.g., powder) forming a melt pool 302 in the powder bed surface 205 (e.g., at least a top deposited layer of material) of the powder bed 121. When the liquid in the melt pool solidifies, this solidified material forms a portion of the build piece 109. FIG. 3 also illustrates the dynamic magnetic field 201 passing through the melt pool in a normal direction. As discussed above, a Thermal Electromagnetic Force (TEMF) is created in the melt pool due to the dynamic magnetic field and the thermoelectric (Seebeck) current. Additionally, when a heat affected zone includes a liquid, the Thermal Electromagnetic Force (TEMF) is created in the liquid of the heat affected zone. Results and details of the TEMF within the melt pool and the heat affected zone will be described in detail later with respect to FIGS. 12-14.

FIG. 4 illustrates an example of segmented electromagnetic coils 403 coupled to each of an inlet duct 404 and an exhaust duct 405 and generating a dynamic magnetic field 401 across the material (e.g., powder or powder bed surface), which as shown in FIG. 4 the dynamic magnetic field may be parallel to a build plate 204 and to a powder bed surface 410. The number of segmented electromagnetic coils may be more or less than the number shown in FIG. 4. The dynamic magnetic field being parallel to the powder bed surface may provide a maximum magnetic flux density 402 at the power surface. In one or more embodiments, the dynamic magnetic field may be at an angle to the build plate and the powder bed surface different from the angle to the build plate and the powder bed surface illustrated in FIG. 4. For example, the dynamic magnetic field may be at an angle to the surface of the powder that provides a maximum magnetic flux density along the powder bed 121. FIG. 4 also illustrates three example build pieces 109 formed on the build plate, where the build plate may be within build cylinder 200. There may be more or less build pieces formed on the build plate than illustrated in FIG. 4. For example, five build pieces may be formed on the build plate using a powder bed fusion (PBF) system or other AM systems. The powder bed fusion system may be the PBF system 100 discussed and illustrated in FIGS. 1A-1E. Also, the PBF system 100 of FIGS. 1A-1E may include the build cylinder. Additionally, the PBF system 100 of FIGS. 1A-1E may include the inlet duct and the exhaust duct. FIG. 4 illustrates each of the inlet duct and the exhaust duct configured to have a gas flow 400 to pass therethrough and includes a high magnetic permeability outer duct wall 407, a low magnetic permeability inner duct wall 408, and a high magnetic permeability inner duct wall 409. The inner and outer walls of each of the inlet duct and the exhaust duct may be cylindrical shaped or any other geometric shape configured to enable the gas flow to pass through the inlet duct, over the powder bed and through the exhaust duct. The magnetic permeability of the inner and outer duct walls is respect to the penetration of the dynamic magnetic field therethrough. FIG. 4 illustrates the segmented electromagnetic coils coupled between the high magnetic permeability outer duct wall 407 and the high magnetic permeability inner duct wall 409, and between the high magnetic permeability outer duct wall 407 and the low magnetic permeability inner duct wall 408. The high magnetic permeability inner duct wall 409 biases the magnetic flux at the powder bed surface 410 (i.e., the top deposited layer of material). The low magnetic permeability inner duct wall may include stainless steel or aluminum or other material, which has a low magnetic flux of the dynamic magnetic field. The high magnetic permeability inner and outer duct walls may include nickel or a nickel alloy or cobalt or iron or other material that has high permeability to the dynamic magnetic field. In one or more embodiments, any type and quantity of an electromagnet that generates a dynamic magnetic field may be coupled to the inlet duct and the exhaust duct. For example, the segmented electromagnetic coils may be independent from one another and each coil may be independently controlled by a controller 406. For example, the controller may be coupled to each of the segmented electromagnetic coils and configured to control each of the segmented electromagnetic coils generated dynamic magnetic field. In one or more embodiments, the controller may control the dynamic magnetic field by changing the magnetic field strength of the dynamic magnetic field. For example, changing the magnetic field strength of the dynamic magnetic field may include changing the magnetic field strength of a dynamic magnetic field from one (e.g., a first) of the segmented electromagnetic coils and changing the magnetic field strength of a dynamic magnetic field from another (e.g., a second) of the segmented electromagnetic coils such that the first segmented electromagnetic coil generates the same or a different magnetic field strength than the second segmented electromagnetic coil. Another example of changing the magnetic field strength of the dynamic magnetic field may include pulsing the dynamic magnetic field and/or reversing the dynamic magnetic field. In one or more embodiments, pulsing the dynamic magnetic field may include the dynamic magnetic field having a pulsed square wave or a pulsed sawtooth wave or a pulsed half-sine wave as shown in FIGS. 6-8 or other pulsed wave forms. In one or more embodiments, reversing the dynamic magnetic field may include the dynamic magnetic field having a reversed square wave or a reversed sawtooth wave or a reversed sinusoidal wave as shown in FIGS. 9-11 or other reversed wave forms.

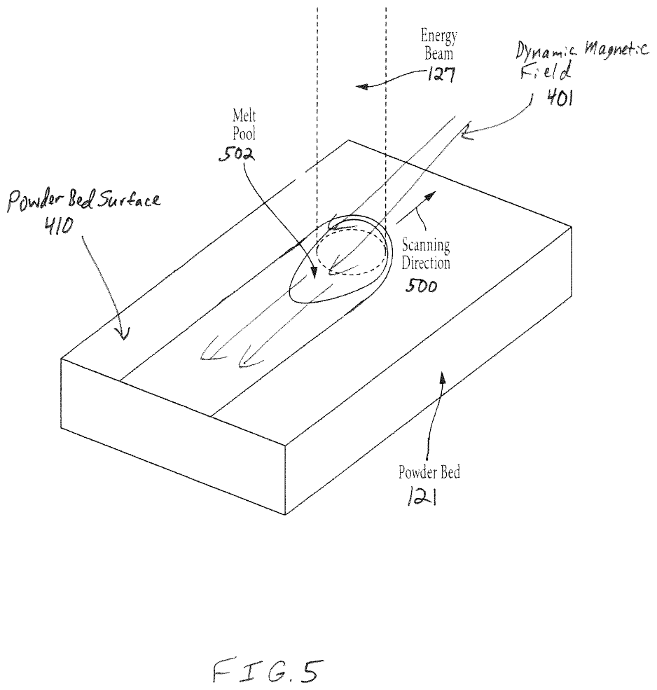

FIG. 5 illustrates a perspective view showing more details of the powder bed surface of FIG. 4. FIG. 5 illustrates a scanning direction 500 of the energy beam 127, where the energy beam melts material (e.g., powder) forming a melt pool 502 in the powder bed surface 410 (e.g., at least a top deposited layer of material) of the powder bed 121. When the liquid in the melt pool solidifies, this solidified material forms a portion of the build piece 109. FIG. 5 also illustrates the dynamic magnetic field 401 passing parallel through the melt pool. As discussed above, a Thermal Electromagnetic Force (TEMF) is created in the melt pool due to the dynamic magnetic field and the thermoelectric (Seebeck) current. Additionally, when the heat affected zone includes a liquid, the Thermal Electromagnetic Force (TEMF) is created in the liquid of the heat affected zone. Results and details of the TEMF within the melt pool and the heat affected zone will be described in detail later with respect to FIGS. 12-14.

FIGS. 6-11 illustrate various example dynamic magnetic fields, which may be controlled by a controller (e.g., controller 206 and 406) and/or generated by an electromagnet such as segmented electromagnetic coils (e.g., segmented electromagnetic coils 203 and 403). These various example dynamic magnetic fields of FIGS. 6-11 may be the dynamic magnetic fields disclosed in the various embodiments. For example, any of the dynamic magnetic fields of FIGS. 6-11 may be the dynamic magnetic fields disclosed and illustrated in FIGS. 2-5.

FIG. 6 illustrates an example of a pulsed dynamic magnetic field B being a pulsed square wave 600. More specifically, FIG. 6 illustrates the pulsed square wave graphed on a horizontal axis of time and a vertical axis of magnitude of the magnetic field.

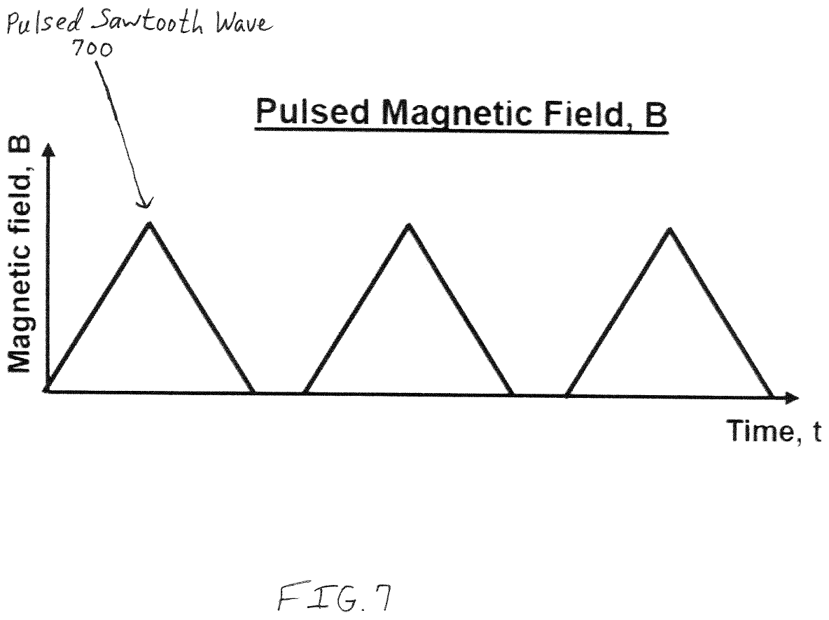

FIG. 7 illustrates an example of a pulsed dynamic magnetic field B being a pulsed sawtooth wave 700. More specifically, FIG. 7 illustrates the pulsed sawtooth wave graphed on a horizontal axis of time and a vertical axis of magnitude of the magnetic field.

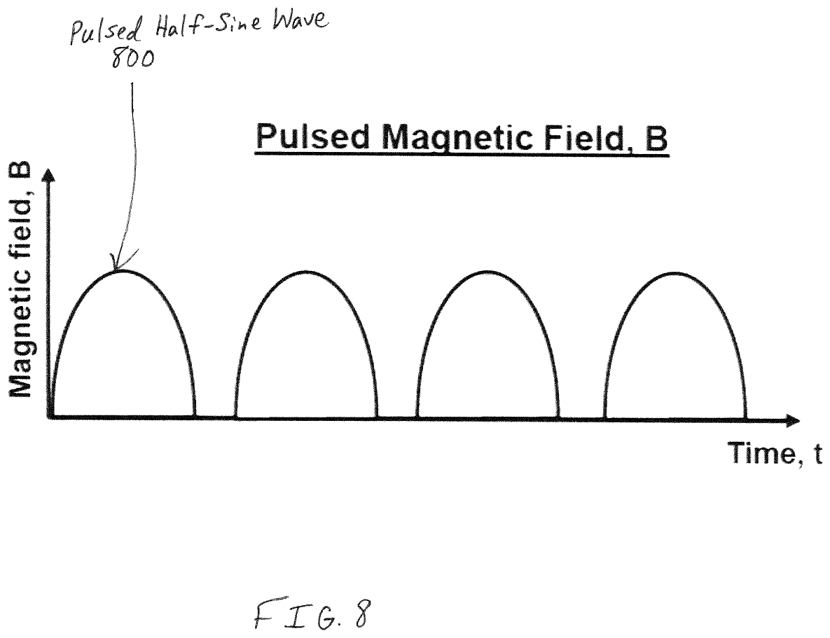

FIG. 8 illustrates an example of a pulsed dynamic magnetic field B being a pulsed half-sine wave 800. More specifically, FIG. 8 illustrates the pulsed half-sine wave graphed on a horizontal axis of time and a vertical axis of magnitude of the magnetic field.

FIG. 9 illustrates an example of a (cyclical) reversed dynamic magnetic field B being a reversed square wave 900. More specifically, FIG. 9 illustrates the reversed square wave graphed on a horizontal axis of time and a vertical axis of magnitude of the magnetic field.

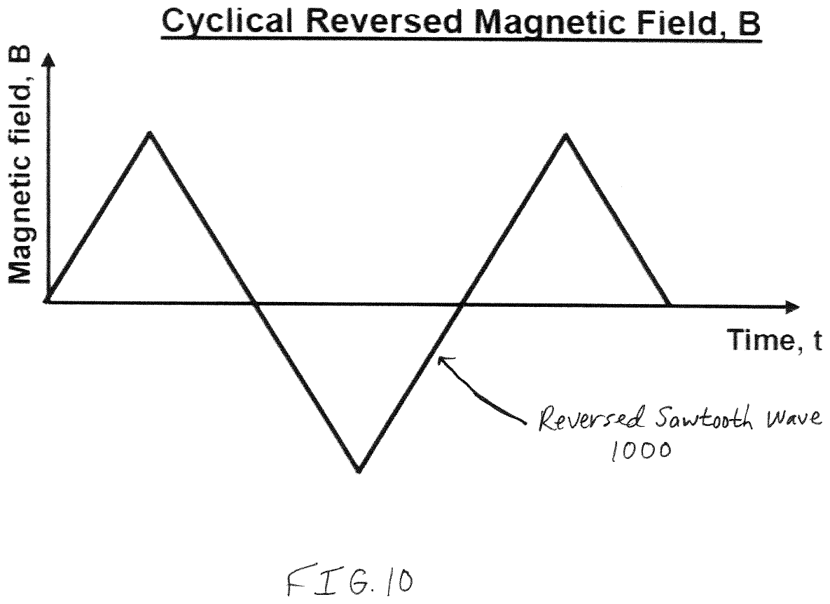

FIG. 10 illustrates an example of a (cyclical) reversed dynamic magnetic B field being a reversed sawtooth wave 1000. More specifically, FIG. 10 illustrates the reversed sawtooth wave graphed on a horizontal axis of time and a vertical axis of magnitude of the magnetic field.

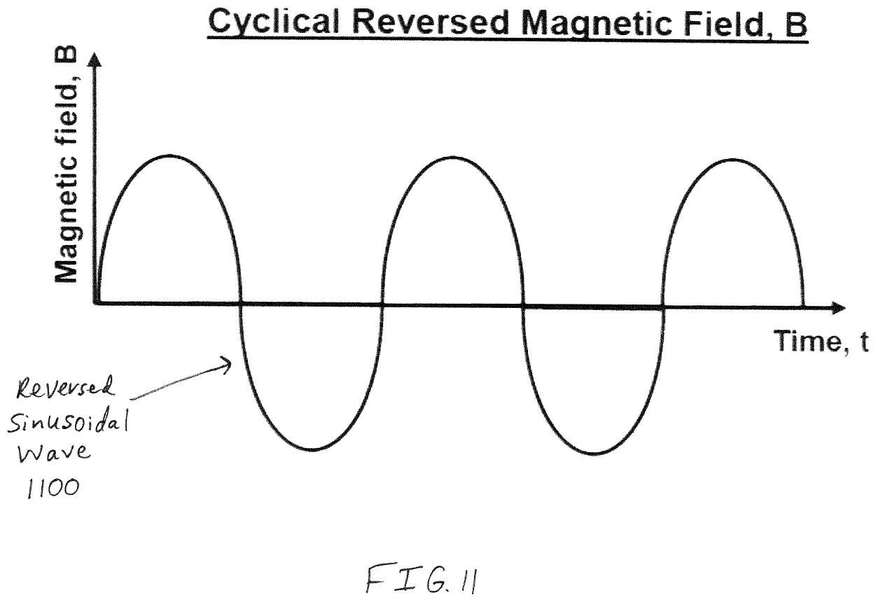

FIG. 11 illustrates an example of a (cyclical) reversed dynamic magnetic field B being a reversed sinusoidal wave 1100. More specifically, FIG. 11 illustrates the reversed sinusoidal wave graphed on a horizontal axis of time and a vertical axis of magnitude of the magnetic field.

FIG. 12 illustrates an example melting process 1200 of a 3D printing process, where the 3D printing process may be laser bed printing, for example, using a powder bed fusion (PBF) system or other AM systems. For example, the powder bed fusion system may be the PBF system 100 discussed and illustrated in FIGS. 1A-1E. FIG. 12 illustrates three layers, Layer N+2, Layer N+1 and Layer N of material of a powder bed (e.g., powder bed 121), where the dynamic magnetic field 201 is normal to the power bed surface and thus, is normal to a melt pool 1203 and a heat affected zone 1206. Energy beam 127 is scanned over material 1202 (e.g., powder) in a scanning direction 1201 such that the energy beam is applied to the material in Layer N+2 forming the melt pool 1203. The melt pool includes a liquid (e.g., liquid material 1204). Additionally, the energy beam may form a heat affected zone 1206 when the energy beam is applied to Layer N+2. Layer N+2 may be a top layer of deposited material. FIG. 12 illustrates Layer N+2 including a solid material 1205, material 1202 (e.g., powder) and a portion (e.g., a first portion) of the melt pool. The solid material 1205 may be previously melted material that has solidified forming a portion of the build piece 109. Layer N+1 includes a solid material 1208, a portion (e.g., a second portion) of the melt pool, and the heat affected zone. The solid material 1208 may be previously melted material that has solidified forming a portion of the build piece 109. The heat affected zone includes a liquid (e.g., liquid material 1207). Layer N includes solid material 1209. The solid material 1209 may be previously melted material that has solidified forming a portion of the build piece 109.

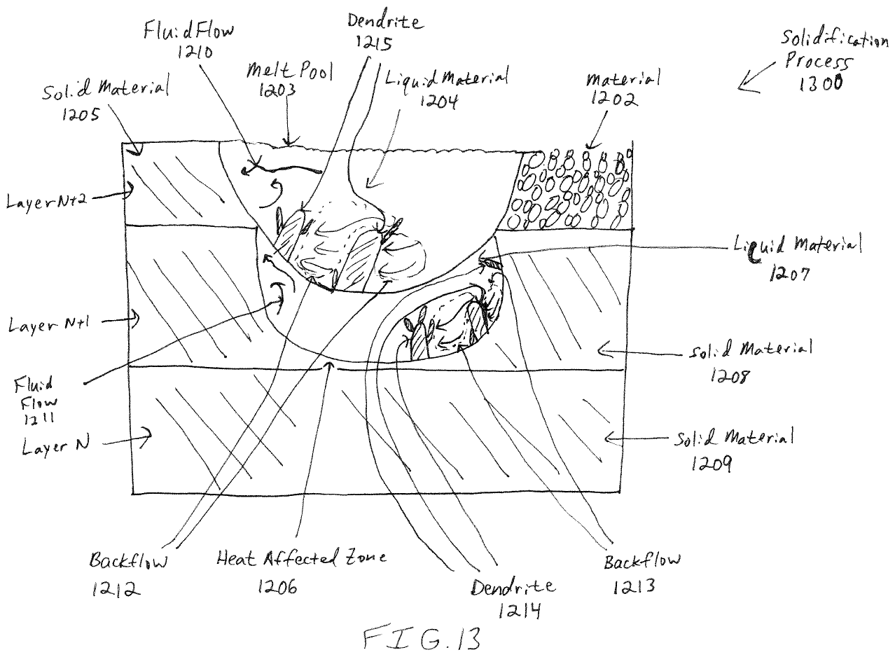

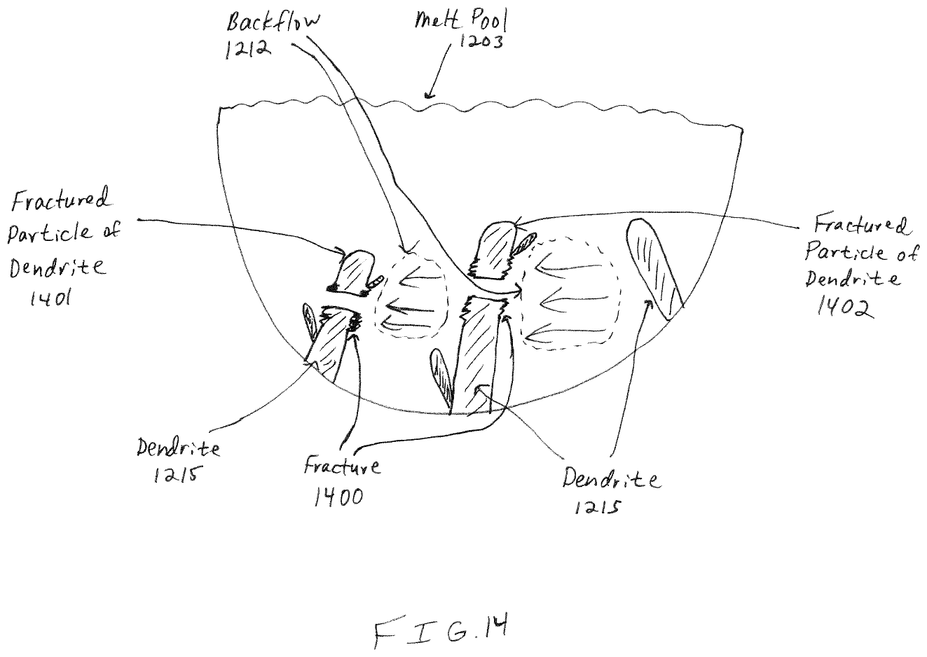

As discussed above, a Thermal Electromagnetic Force (TEMF) is created in the melt pool and in the heat affected zone due to the dynamic magnetic field and the thermoelectric (Seebeck) current. The TEMF acts on the metal pool and the heat affected zone such that the TEMF creates a fluid flow 1210 of the liquid (e.g., the liquid material 1204) in the metal pool and creates a fluid flow 1211 of the liquid (e.g., the liquid material 1207) in the heat affected zone. For example, the TEMF creates a fluid flow within the liquid of the metal pool and also creates a fluid flow within the liquid of the heat affected zone. In one or more embodiments, the melt pool may be included only in Layer N+2 or may be included in more layers than illustrated in FIG. 12. For example, melt pool may not be included in Layer N+1 or Layer N. In one or more embodiments, the heat affected zone may be included in more layers than illustrated in FIG. 12. In one or more embodiments, the energy beam may not create a liquid in a heat affected zone and thus, the TEMF may act on only one liquid, which is the liquid within the melt pool. As will be explained in more detail in association with FIGS. 13 and 14, the TEMF may create a back flow of the liquid in the metal pool and create a back flow of the liquid in the heat affected zone. At least some of the liquid back flow in each of the metal pool and the heat affected zone may be between dendrites.

The melting process of FIG. 12 may include a more detailed view of the features of FIGS. 2 and 3. For example, FIG. 12 may represent the powder bed and melt pool of FIGS. 2 and 3 and thus, include the features in FIGS. 2 and 3 that generate and control the dynamic magnetic field such that the TEMF creates a fluid flow within the liquid of the metal pool and also creates a fluid flow within the liquid of the heat affected zone. However, the melting process of FIG. 12 may include a more detailed view of the features of FIGS. 4 and 5 and have the dynamic magnetic field applied parallel to the power bed surface instead of the dynamic magnetic field applied normal to the power bed surface, which is shown in FIG. 12.

FIG. 13 illustrates an example solidification process 1300 of a 3D printing process, where the 3D printing process may be laser bed printing, for example, using a powder bed fusion (PBF) system or other AM systems. For example, the powder bed fusion system may be the PBF system 100 discussed and illustrated in FIGS. 1A-1E. The solidification process of FIG. 13 include the features of FIG. 12, except for the purpose of clarity dynamic magnetic field 201 is not shown in FIGS. 13 and 14. For example, FIG. 13 illustrates the solidification process of the melt pool and the heat affected zone of FIG. 12. More specifically, FIG. 13 illustrates a stage of the solidification process that includes some of the liquid material 1204 within the melt pool 1203 solidified forming dendrites 1215 and some of the liquid material 1207 within the heat affected zone 1206 solidified forming dendrites 1214. Each component of the dendrites 1214 and 1215 may be considered a dendritic arm. For example, the left most dendrite 1215 illustrated in FIG. 13 includes three rounded components forming the dendrite 1215 and each of these three rounded components may be considered a dendritic arm. From the TEMF, fluid flow 1210 and fluid back flow 1212 are created within the melt pool and also fluid flow 1211 and fluid back flow 1213 are created in the heat affected zone. The back flow is based on the fluid flow. For example, the fluid flow may create a flow of the liquid in a direction such as a back direction (i.e., the left direction shown in FIG. 13) and between the dendrites. At least some of the back flow in each of the melt pool and the heat affected zone are between the dendrites. This back flow between the dendrites applies a force to the dendrite such that the force acting on the dendrite creates fractures 1400 (e.g., micro-fracture), and particles break away from the dendrite as shown in FIG. 14.

FIG. 14 illustrates fractured particles 1401 and 1402 of the dendrites 1215 in the melt pool 1203 resulting from the force applied to the dendrites by the back flow 1212. More specifically, FIG. 14 illustrates factures 1400 on the dendrites 1215, which are between the back flow, result from the force applied to the dendrites by the back flow. Also, due to the factures, fractured particles 1401 and 1402 may break off from the dendrite at the facture or adjacent the facture resulting from the force applied to the dendrites by the back flow. These fractured particles my become nucleation sites to refine the gain within the material of the build piece. Moreover, refining the grain may include a finer grain, which increases material strength and elongation, removes high grain-boundary angles, and reduces formation of residual stress cracks. In one or more embodiments, the back flow may create a plurality of fractures in a plurality of different locations on the dendrites and thus, a plurality of particles may break away from the dendrites resulting from the force created by the back flow on the dendrites. FIG. 14 is an illustration of the dendrites of the melt pool but the dendrites in the heat affected zone are affected by the back flow in the same manner as described in FIG. 14. For example, factures on the dendrites 1214, which are between the back flow 1213 result from the force applied to the dendrites by the back flow. Also, due to the factures, fractured particles may break off from the dendrite at the facture or adjacent the facture resulting from the force applied to the dendrites by the back flow. These fractured particles may become nucleation sites to refine the gain within the material of the build piece. Moreover, refining the grain may include a finer grain, which increases material strength and elongation, removes high grain-boundary angles, and reduces formation of residual stress cracks. In one or more embodiments, the back flow may create a plurality of fractures in a plurality of different locations on the dendrites and thus, a plurality of particles may break away from the dendrites due to the force created by the back flow on the dendrites.

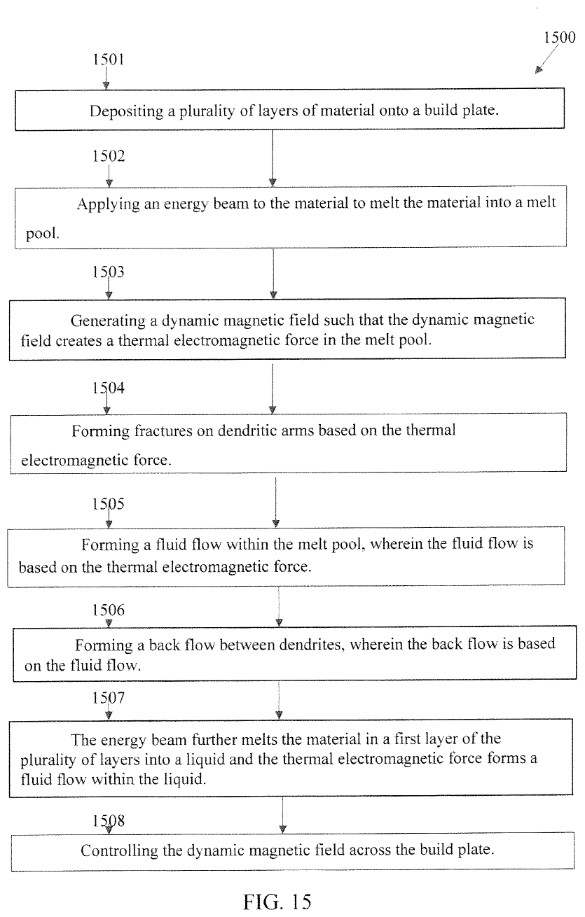

FIG. 15 is a flowchart showing an example method 1500 of influencing the melt pool and a heat affected zone with a dynamic magnetic field in accordance with the apparatuses, systems and methods described herein, with each of blocks 1504-1508 being optional. The example method may be implemented using 3D printing. The printing process may be laser bed printing, for example, using a powder bed fusion (PBF) system or other AM systems. For example, the powder bed fusion system may be the PBF system 100 discussed and illustrated in FIGS. 1A-1E.

At block 1501, the method may include depositing a plurality of layers of material onto a build plate. The material may be a powder such as a metal powder. The metal powder may be an alloy powder such as an aluminum alloy powder or a nickel alloy powder or other type of material or alloys used to made a structure. A depositor may be used to deposit the plurality of layers of material.

At block 1502, the method may include applying an energy beam to the material to melt the material into a melt pool. A deflector may be used to apply the energy beam to the material. In one or more embodiments, the deflector may include deflection plates that can generate an electric field or a magnetic field that selectively deflects the energy beam to cause the energy beam to scan across areas designated to be fused or melted. In one or more embodiments, the deflector may include an optical system that uses reflection and/or refraction to manipulate the energy beam to scan selected areas of the layer of material to be melted or fused. In one or more embodiments, the deflector may include one or more gimbals and actuators that can rotate and/or translate an energy beam source to position the energy beam. The energy beam may be an electron beam or a laser beam or other type of beam that melts the material in one or more of the plurality of deposited layers.

At block 1503, the method may include generating a dynamic magnetic field such that the dynamic magnetic field creates a thermal electromagnetic force in the melt pool. An electromagnet may generate various types of dynamic magnetic fields. For example, one or more electromagnetic coils such as segmented electromagnetic coils or segmented, independent electromagnetic coils may generate various types of dynamic magnetic fields. The various dynamic magnetic fields may include a pulsed square wave or a pulsed sawtooth wave or a pulsed half-sine wave or a reversed square wave or a reversed sawtooth wave or a reversed sinusoidal wave. The thermal electromagnetic force may be controlled and/or directed within the melt pool. The creation of the thermal electromagnetic force results from the generated dynamic magnetic field and the temperature different in the material caused by the energy beam melting the material.

At block 1504, the method may include forming fractures on dendritic arms based on the thermal electromagnetic force. The creation of the thermal electromagnetic force as explained above creates a fluid flow and a fluid back flow within the melt pool and a heat affected zone, if the heat affected zone includes a liquid, when the dynamic magnetic field is controlled and/or directed within the melt pool. The back flow may be between dendrites formed in a solidification process (i.e., some of the liquid material within the melt pool is solidified forming dendrites) of the 3D printing process. This back flow between the dendrites applies a force to the dendrite, for example dendritic arms, such that the force acting on the dendrite (e.g., dendritic arms), creates fractures (e.g., micro-fracture) in the dendrite and particles break away from the dendrite at the facture or adjacent the facture resulting from the force applied to the dendrites by the back flow.

At block 1505, the method may include forming a fluid flow within the melt pool, wherein the fluid flow is based on the thermal electromagnetic force. As discussed above, the creation of the thermal electromagnetic force creates a fluid flow within the melt pool when the dynamic magnetic field is controlled and/or directed within the melt pool.

At block 1506, the method may include forming a fluid backflow between dendrites, wherein the fluid backflow is based on the fluid flow. Also, as discussed above, the creation of the thermal electromagnetic force creates a fluid flow and a back flow within the melt pool when the dynamic magnetic field is controlled and/or directed within the melt pool. The back flow may be based on the fluid flow. For example, as the fluid is moving within the melt pool, a flow of the liquid may be in a direction such as a back direction (e.g., the left direction shown in FIG. 13) is between dendrites and thus, this flow may be considered a back flow.

At block 1507, the method may include the energy beam further melts the material in a first layer of the plurality of layers into a liquid and the thermal electromagnetic force forms a fluid flow within the liquid. The energy beam may melt material forming a melt pool in one or more layers of the plurality of deposited layers. The energy beam may additionally create a heat affected zone in one or more layers of the plurality of deposited layers. Thus, in one or more embodiments, the energy beam may melt material forming a melt pool in one or more layers of the plurality of deposited layers and the energy beam may additionally create a heat affected zone in one or more layers of the plurality of deposited layers. In one or more embodiments, the heat affected zone may include a liquid, which may have resulted from the energy beam heating and melting material within the heat affected zone. When the heat affected zone includes a liquid, the creation of the thermal electromagnetic force creates a fluid flow within the liquid of the heat affected zone when the dynamic magnetic field is controlled and/or directed within liquid of the heat affected zone.

At block 1508, the method may include controlling the dynamic magnetic field across the build plate. In one or more embodiments, controlling the dynamic magnetic field across the build plate and/or the surface of the powder bed and/or the surface of the powder may include directing the dynamic magnetic field normal (i.e., perpendicular) to the build plate and the material. In one or more embodiments, controlling the dynamic magnetic field across the build plate and/or the surface of the powder bed and/or the surface of the powder may include directing the dynamic magnetic field parallel to the build plate and the material. In one or more embodiments, controlling the dynamic magnetic field across the build plate and/or the surface of the powder bed and/or the surface of the powder may include tuning the build plate to increase a magnetic flux through the build plate. For example, tuning the build plate may include forming the build plate with a shape which increases the magnetic flux through the build plate and/or forming the build plate with a nickel material or a nickel alloy or cobalt or iron or other material that has high permeability to the dynamic magnetic field. In one or more embodiments, changing the magnetic field strength of the dynamic magnetic field may include pulsing the dynamic magnetic field or reversing the dynamic magnetic field. In one or more embodiments, pulsing the dynamic magnetic field may include a pulsed square wave or a pulsed sawtooth wave or a pulsed half-sine wave. In one or more embodiments, reversing the dynamic magnetic field may include a reversed square wave or a reversed sawtooth wave or a reversed sinusoidal wave. A controller may be used to control the dynamic magnetic field being generated from, for example, an electromagnet.

In any of the disclosure and embodiments, coupling and coupler may include mechanical, electrical, chemical or a combination thereof. For example, mechanical fasteners, electrical coupling and adhesives may include coupling or couplers.

The previous description is provided to enable any person skilled in the art to practice the various aspects described herein. Various modifications to these example embodiments presented throughout this disclosure will be readily apparent to those skilled in the art, and the concepts disclosed herein may be applied to other techniques of forming and assembling the disclosed example embodiments. Thus, the claims are not intended to be limited to the exemplary embodiments presented throughout the disclosure, but are to be accorded the full scope consistent with the language of the claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method, comprising:
depositing a plurality of layers of material onto a build plate;
applying an energy beam to the material to melt the material into a melt pool; and
generating a dynamic magnetic field, such that the dynamic magnetic field creates a thermal electromagnetic force in the melt pool.

2. The method of claim 1, further comprising:
forming fractures on dendritic arms based on the thermal electromagnetic force.

3. The method of claim 1, further comprising:
forming a fluid flow within the melt pool, wherein the fluid flow is based on the thermal electromagnetic force.

4. The method of claim 3, further comprising:
forming a fluid backflow between dendrites, wherein the fluid backflow is based on the fluid flow.

5. The method of claim 3, wherein the energy beam further melts the material in a first layer of the plurality of layers into a liquid.

6. The method of claim 5, wherein the thermal electromagnetic force forms a fluid flow within the liquid.

7. The method of claim 1, further comprising:
controlling the dynamic magnetic field across the build plate.

8. The method of claim 7, wherein controlling the dynamic magnetic field comprises directing the dynamic magnetic field normal to the build plate and the material.

9. The method of claim 7, wherein controlling the dynamic magnetic field comprises directing the dynamic magnetic field parallel to the build plate and the material.

10. The method of claim 7, wherein controlling the dynamic magnetic field comprises tuning the build plate to increase a magnetic flux through the build plate.

11. The method of claim 10, wherein tuning the build plate comprises forming the build plate with a nickel material.

12. The method of claim 7, wherein controlling the dynamic magnetic field comprises changing a magnetic field strength of the dynamic magnetic field.

13. The method of claim 12, wherein changing the magnetic field strength comprises pulsing the dynamic magnetic field.

14. The method of claim 13, wherein pulsing the dynamic magnetic field comprises a pulsed square wave or a pulsed sawtooth wave or a pulsed half-sine wave.

15. The method of claim 12, wherein changing the magnetic field strength comprises reversing the dynamic magnetic field.

16. The method of claim 15, wherein reversing the dynamic magnetic field comprises a reversed square wave or a reversed sawtooth wave or a reversed sinusoidal wave.

17. A three dimensional (3D) printing system, comprising:
a depositor configured to deposit material onto a build plate;
an energy beam deflector that applies an energy beam to melt the material into a melt pool; and
an electromagnet configured to generate a dynamic magnetic field across the material, such that the dynamic magnetic field creates a thermal electromagnetic force in the melt pool.

18. The 3D printing system of claim 17, wherein the build plate comprises a nickel material.

19. The 3D printing system of claim 17, further comprising:
a controller configured to pulse the dynamic magnetic field.

20. The 3D printing system of claim 19, wherein the pulsed dynamic magnetic field comprises a pulsed square wave or a pulsed sawtooth wave or a pulsed half-sine wave.

21. The 3D printing system of claim 17, further comprising:
a controller configured to reverse the dynamic magnetic field.

22. The 3D printing system of claim 21, wherein the reversed dynamic magnetic field comprises a reversed square wave or a reversed sawtooth wave or a reversed sinusoidal wave.

23. The 3D printing system of claim 17, further comprising:
a build cylinder, wherein the electromagnet is coupled to the build cylinder.

24. The 3D printing system of claim 23, wherein the electromagnet comprises electromagnetic coils around the build cylinder.

25. The 3D printing system of claim 17, further comprising:
an inlet duct and an exhaust duct, the electromagnet comprises a first set of electromagnetic coils and a second set of electromagnetic coils, and wherein the first set of electromagnetic coils is coupled to the inlet duct and the second set of electromagnetic coils is coupled to the exhaust duct.

26. The 3D printing system of claim 25, wherein the inlet duct is configured to provide a gas flow across the material, and the exhaust duct is configured to receive the gas flow.

27. The 3D printing system of claim 17, wherein the electromagnet comprises a plurality of segmented electromagnetic coils.

28. The 3D printing system of claim 27, wherein a first coil of the plurality of segmented electromagnetic coils is configured to generate a first dynamic magnetic field, and a second coil of the plurality of segmented electromagnetic coils is configured to generate a second dynamic magnetic field, wherein a magnetic field strength of the first dynamic magnetic field is different from a magnetic field strength of the second dynamic magnetic field.
